(19) United States
(12) Patent Application Publication
(10) Pub. No.: US 2016/0070493 A1
(43) Pub. Date: Mar. 10, 2016

(54) DATA STORAGE DEVICE AND METHOD OF OPERATING THE SAME

(71) Applicant: SAMSUNG ELECTRONICS CO., LTD., SUWON-SI (KR)

(72) Inventors: SANG JIN OH, Suwon-si (KR); MOON SANG KWON, Seoul (KR)

(21) Appl. No.: 14/843,400

(22) Filed: Sep. 2, 2015

(30) Foreign Application Priority Data
Sep. 4, 2014 (KR) 10-2014-0117458

(51) Int. Cl. G06F 3/06

(52) U.S. Cl. CPC G06F 3/0619; G06F 3/065; G06F 3/0688; G06F 3/0622; G06F 3/0685; G06F 3/0637

(57) ABSTRACT

A data storage device includes a memory including a first region that stores an application executed by a host, a second region that stores user data, and a meta region, as well as a storage controller configured to control an operation of the memory. The storage controller transmits first data including the application stored in the first region to the host in response to a first request received from the host after being connected with the host, stores product registration information transmitted from the host in the meta region, resets a connection between the data storage device and the host in response to a connection reset command received from the host, and transmits second data stored in the second region to the host in response to a second request received from the host after the connection is reset.

### CROSS-REFERENCE TO RELATED APPLICATIONS

This application claims priority under 35 U.S.C. §119 to Korean Patent Application No. 10-2014-0117458 filed on Sep. 4, 2014, the disclosure of which is incorporated by reference herein in its entirety.

TECHNICAL FIELD

Exemplary embodiments of the inventive concept relate to a data storage device, and more particularly, to a data storage device capable of processing a write command for a read-only region in which writing data is not allowed, and a method of operating the same.

DISCUSSION OF THE RELATED ART

A self encryption drive (SED) automatically performs encryption and decryption and supports pre-boot authentication. When a system is booted, a basic input/output system (BIOS) reads a master boot record (MBR). When the system is set to be in a pre-boot authentication mode, it loads a pre-boot operating system (OS) through a pre-boot area instead of loading the OS through the MBR.

A user is permitted to go through authentication through the pre-boot OS. When the authentication is successful, the drive allows the original MBR to be loaded. Thus, a user cannot access the MBR without authentication, thereby protecting the MBR. This functionality is referred to as a shadow MBR.

A shadow MBR is a write-protected read-only region. When an OS issues a write command for the shadow MBR, all write commands for the shadow MBR are aborted. Once all write commands are aborted, the OS issues a new write command for the shadow MBR. As a result, a system may endlessly repeat the issuing and aborting of a write command.

### SUMMARY

Exemplary embodiments of the inventive concept provide a data storage device capable of processing a write command for a write-protected read-only region and a method of operating the same.

According to an exemplary embodiment of the inventive concept, a method of operating a data storage device which operates according to control of a host is provided. The method includes receiving an operating voltage from the host, transmitting first data stored in a first region of the data storage device to the host in response to a first request transmitted by the host, storing product registration information transmitted from the host in a meta region of the data storage device, resetting a connection between the data storage device and the host in response to a connection reset command output from the host, and transmitting second data stored in a second region of the data storage device to the host in response to a second request transmitted by the host after the connection is reset. The first data may include an application executed by the host.

In an exemplary embodiment, the first region may be smaller than the second region.

In an exemplary embodiment, the first region may be a write-protected read-only region and the second region may be a user data region to which user data is written.

In an exemplary embodiment, the product registration information may include a product name and a password.

In an exemplary embodiment, the product registration information may include a product name and indicator data indicating whether a password has been set. The indicator data includes the password when the password has been set.

In an exemplary embodiment, the method may further include receiving a write command for the first region from the host while the application is being executed by the host, storing write data corresponding to the write command in a random access memory (RAM) included in the data storage device, and transmitting a response to the write command to the host.

In an exemplary embodiment, the method may further include receiving a write command for the first region from the host while the application is being executed by the host, generating a new address mapping table for write data corresponding to the write command, storing the write data in the first region using the new address mapping table, and transmitting a response to the write command to the host.

In an exemplary embodiment, the method may further include storing the new address mapping table in a RAM included in the data storage device.

In an exemplary embodiment, the product registration information and the connection reset command may be transmitted from the host by the application executed by the host.

In an exemplary embodiment, the data storage device may be a solid state drive (SSD), a universal flash storage (UFS), a universal serial bus (USB) flash drive, a multimedia card (MMC), or a hard disk drive.

According to an exemplary embodiment of the inventive concept, a method of operating a data storage device which operates according to control of a host is provided. The method includes receiving an operating voltage from the host, transmitting first data stored in a first region of the data storage device to the host in response to a first request transmitted by the host, receiving a first password from the host, comparing a second password stored in a meta region of the data storage device with the first password, transmitting an acknowledgement signal to the host in response to determining that the first password matches the second password, resetting a connection between the data storage device and the host in response to a connection reset command output from the host based on the acknowledgement signal, and transmitting second data stored in a second region of the data storage device to the host in response to a second request transmitted by the host after the connection is reset. The first data may include an application executed by the host.

In an exemplary embodiment, the first password and the connection reset command may be transmitted from the host by the application executed by the host.

According to an exemplary embodiment of the inventive concept, a data storage device includes a memory and a storage controller configured to control an operation of the memory. The memory includes a first region configured to store an application executed by a host, a second region configured to store user data, and a meta region. The storage controller is further configured to transmit first data to the host in response to a first request received from the host upon the storage controller being connected to the host. The first data includes the application stored in the first region. The storage controller is further configured to store product registration information transmitted from the host in the meta region, reset a connection between the data storage device and the host in response to a connection reset command received from the host, and transmit second data stored in the second region to the host in response to a second request received from the host after the connection is reset.

### BRIEF DESCRIPTION OF THE DRAWINGS

The above and other features of the inventive concept will become more apparent by describing in detail exemplary embodiments thereof with reference to the accompanying drawings, in which:

FIG. 1 is a block diagram of a data processing system according to an exemplary embodiment of the inventive concept.

FIGS. 2A through 2E are conceptual diagrams showing the initialization of a data storage device illustrated in FIG. 1 according to an exemplary embodiment of the inventive concept.

FIG. 3 is a data flowchart showing a procedure for initializing a data storage device using the data processing system illustrated in FIG. 1 according to an exemplary embodiment of the inventive concept.

FIGS. 4A and 4B are data flowcharts showing a procedure for accessing a data storage device using the data processing system illustrated in FIG. 1 according to an exemplary embodiment of the inventive concept.

FIG. 5 is a data flowchart showing a procedure for processing a write command for a write-protected read-only region using volatile memory according to an exemplary embodiment of the inventive concept.

FIG. 6 is a diagram showing data flow in a procedure for processing a write command for a write-protected read-only region using non-volatile memory according to an exemplary embodiment of the inventive concept.

FIG. 7 is a diagram of a new address mapping table generated for the procedure illustrated in FIG. 6 according to an exemplary embodiment of the inventive concept.

### DETAILED DESCRIPTION OF THE EXEMPLARY EMBODIMENTS

Exemplary embodiments of the inventive concept will be described more fully hereinafter with reference to the accompanying drawings. In the drawings, the size and relative sizes of layers and regions may be exaggerated for clarity. Like reference numerals may refer to like elements throughout the accompanying drawings.

It will be understood that when an element is referred to as being “connected” or “coupled” to another element, it can be directly connected or coupled to the other element or intervening elements may be present.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

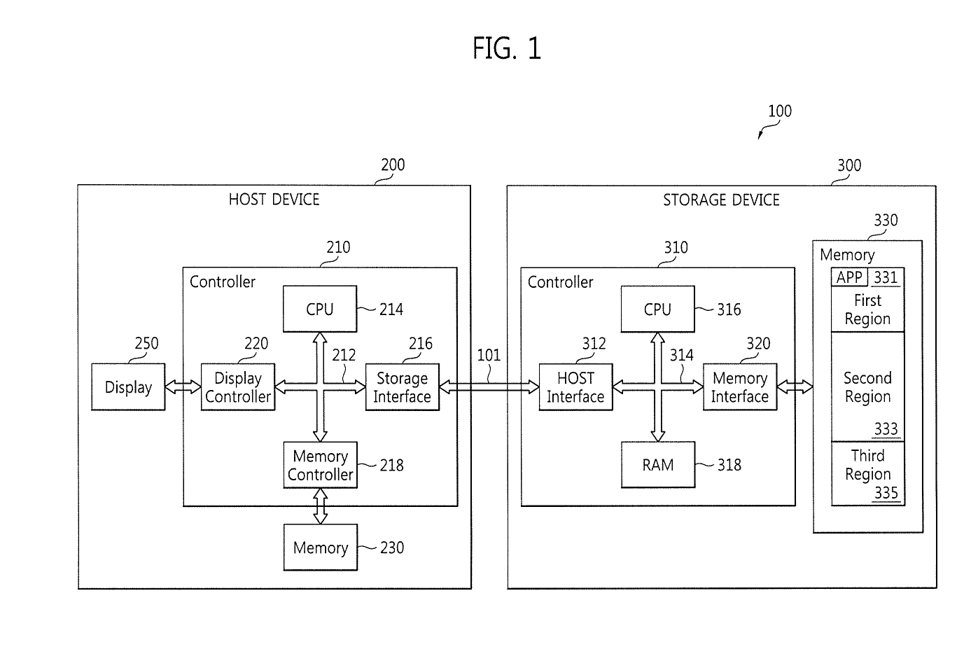

FIG. 1 is a block diagram of a data processing system 100 according to an exemplary embodiment of the inventive concept. The data processing system 100 includes a host device (also referred to herein as a host) 200 and a data storage device (also referred to herein as a storage device) 300.

The host device 200 and the data storage device 300 may communicate with each other through an interface 101. The interface 101 may be, for example, a serial advanced technology attachment (SATA) interface, a serial attached SCSI (SAS) interface, a peripheral component interconnect express (PCIe) interface, a non-volatile memory express (NVMe), or a universal serial bus (USB) interface.

The host device 200 may be implemented as, for example, a personal computer (PC), a television (TV), a digital TV (DTV), an Internet Protocol TV (IPTV), a desktop computer, a laptop computer, a computer workstation, a tablet PC, a video game platform (or a video game console), a server, or a portable electronic device. The portable electronic device may be, for example, a cellular phone, a smartphone, a personal digital assistant (PDA), an enterprise digital assistant (EDA), a digital still camera, a digital video camera, a portable multimedia player (PMP), a personal navigation device or portable navigation device (PND), a mobile internet device (MID), a wearable computer, an Internet of Things (IoT) device, an Internet of Everything (IoE) device, or an e-book.

The host device 200 includes a host controller 210, a memory 230, and a display 250. The host controller 210 may control the operations of the memory 230, the display 250, and/or the data storage device 300. The host controller 210 may be implemented as, for example, a printed circuit board (PCB), a motherboard, an integrated circuit (IC), a system-on-chip (SoC), an application processor (AP), or a mobile AP.

The host controller 210 includes a central processing unit (CPU) 214, a storage interface 216, a memory controller 218, and a display controller 220. The host controller 210 may also include a first encryption/decryption engine.

The CPU 214 may control the overall operation of the host controller 210. For example, the CPU 214 may execute an application (APP) and an operating system (OS), which will be described below. The CPU 214 may control the operations of the storage interface 216, the memory controller 218, and the display controller 220 through a bus 212. In addition, the CPU 214 may control the operation of the first encryption/decryption engine. The first encryption/decryption engine may encrypt data to be transmitted to the data storage device 300 through the storage interface 216 and may decrypt encrypted data received from the data storage device 300 through the storage interface 216.

The storage interface 216 may transmit and receive instructions and/or data (including encrypted data) to and from a host interface 312 included in the data storage device 300. The storage interface 216 may provide an operating voltage for the data storage device 300 when the data storage device 300 is connected to the host device 200.

The memory controller 218 may communicate data with the memory 230 according to the control of the CPU 214. The memory 230 may be formed with volatile memory or non-volatile memory. The memory 230 may be removable or non-removable.

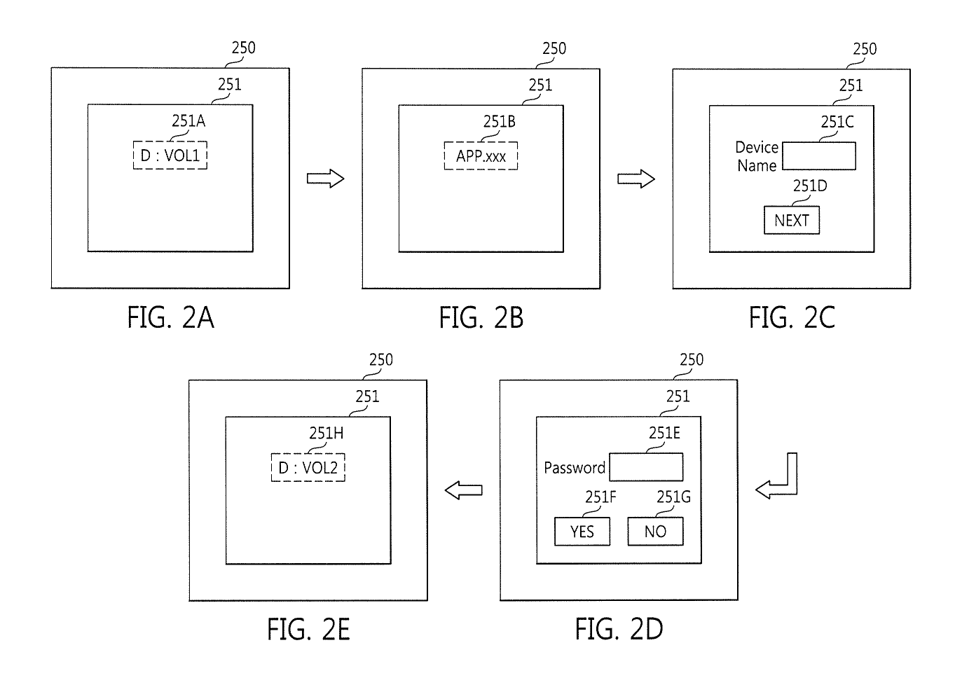

The display controller 220 may transmit display data to the display 250 according to the control of the CPU 214. For example, when an application APP transmitted from the data storage device 300 is executed by the CPU 214, the display controller 220 may transmit data in a first region 331, data in a second region 333, and/or a graphical user interface (GUI) to the display 250. The GUI according to exemplary embodiments of the inventive concept is further described with reference to FIGS. 2A through 2E. The display 250 may be implemented as, for example, a monitor, a TV monitor, a projection device, a thin film transistor-liquid crystal display (TFT-LCD), a light emitting diode (LED) display, an organic LED (OLED) display, an active-matrix OLED (AMOLED) display, or a flexible display.

According to exemplary embodiments, the host controller 210 and the memory 230 may be integrated into an SoC and packaged into a single package.

The data storage device 300 may be implemented, for example, as a flash-based data storage device. However, exemplary embodiments of the inventive concept are not limited thereto. The data storage device 300 may be implemented as, for example, a solid state drive (SSD), an embedded SSD (eSSD), a secure digital (SD) card, a multimedia card (MMC), an embedded MMC (eMMC), a universal flash storage (UFS), or a USB flash drive. The data storage device 300 may be a removable external drive. The data storage device 300 may be a hard disk drive.

The data storage device 300 includes a storage controller 310 and a memory 330. The storage controller 310 may process data transferred between the host device 200 and the memory 330. The storage controller 310 may control an access operation such as, for example, a program operation, a read operation, and/or an erase operation, on the memory 330. The storage controller 310 may be implemented as, for example, an IC or an SoC.

The storage controller 310 may include the host interface 312, a CPU 316, a random access memory (RAM) 318, and a memory interface 320. When the first encryption/decryption engine is included in the host controller 210 of the host device 200, the storage controller 310 may also include a second encryption/decryption engine corresponding to the first encryption/decryption engine. The second encryption/decryption engine may decrypt encrypted data received from the host device 200 and may encrypt data to be transmitted to the host device 200.

The host interface 312 may provide at least one operating voltage related to an operation voltage provided through the storage interface 216 for the host interface 312, the CPU 316, the RAM 318, the memory interface 320, and the memory 330. The same or different operating voltages may be provided for the host interface 312, the CPU 316, the RAM 318, the memory interface 320, and the memory 330, respectively. The host interface 312 may include a voltage generator which generates the operating voltages for the host interface 312, the CPU 316, the RAM 318, the memory interface 320, and the memory 330.

The host interface 312 may transmit or receive data and/or instructions to or from the storage interface 216. The CPU 316 may control the host interface 312, the RAM 318, and/or the memory interface 320 through a bus 314.

Although only one CPU 316 is illustrated in FIG. 1 for convenience of description, exemplary embodiments of the inventive concept are not limited thereto. For example, according to exemplary embodiments, the CPU 316 may be replaced with a plurality of CPUs. For example, a group of CPUs in the storage controller 310 may include a first CPU controlling the operation of the host interface 312 and a second CPU controlling the operation of the memory interface 320. The CPU 214 of the host controller 210 may similarly be replaced with a plurality of CPUs in exemplary embodiments.

The RAM 318 may operate as an operation memory of the CPU 316 according to the control of the CPU 316 or the control of a memory controller which operates according to the control of the CPU 316. The RAM 318 may store a first address mapping table loaded from the memory 330 and/or a second address mapping table generated by the CPU 316. An address mapping table may define mapping between a logical address and a physical address. The RAM 318 may be formed with volatile memory such as, for example, dynamic RAM (DRAM) or static RAM (SRAM). However, exemplary embodiments of the inventive concept are not limited thereto.

The memory interface 320 may control (e.g., interface) data communication between the storage controller 310 and the memory 330 according to the control of the CPU 316. When the memory 330 is flash-based memory, the memory interface 320 may be, for example, a flash memory interface (e.g., a flash memory controller). The flash-based memory may be, for example, NAND flash memory or NOR flash memory.

In an exemplary embodiment of the present inventive concept, the memory 330 may include a three-dimensional (3D) memory array. The 3D memory array may be monolithically formed in one or more physical levels of arrays of memory cells having an active area disposed above a silicon substrate and circuitry associated with the operation of those memory cells. The associated circuitry may be above or within the substrate. The term “monolithic” means that layers of each level of the array are deposited (e.g., directly deposited) on the layers of each underlying level of the array.

In an exemplary embodiment of the present inventive concept, the 3D memory array includes vertical NAND strings that are vertically oriented such that at least one memory cell is located over another memory cell. The at least one memory cell may include a charge trap layer. U.S. Pat. Nos. 7,679,133, 8,553,466, 8,654,587 and 8,559,235, and U.S. Pat. Pub. No. 2011/0233648, which are hereby incorporated by reference, describe suitable configurations for three-dimensional memory arrays, in which the three-dimensional memory array is configured as a plurality of levels with word lines and/or bit lines shared between levels.

The memory 330 includes the first region 331, the second region 333, and a third region 335. The first region 331 is a write-protected read-only region to which the host device 200 is not permitted to write data. The first region 331 may be, for example, a shadow master boot record (MBR). An application APP, which will be described in further detail below, is stored in the first region 331. The second region 333 is a user data region which the host device 200 is permitted to write data to and is permitted to read data from. The second region 333 may be bigger than the first region 331, however, exemplary embodiments of the inventive concept are not limited thereto. The entire region of the memory 330 except for the first region 331 and the third region 335 is referred to as the second region 333.

The third region 335 is a metadata region or meta region in which product registration information transmitted from the host device 200 may be stored. The product registration information may include, for example, a product name and indicator data indicating whether a password has been set (e.g., set up by a user). For example, when a password has been set up by a user for the data storage device 300, the indicator data may include the password and a first indicator bit indicating that the password has been set up. However, when a password has not been set up by a user for the data storage device 300, the indicator data may include a second indicator bit indicating that no password has been set up.

Each of the regions 331, 333, and 335 may be formed in one chip or different chips. For example, the first region 331 may be formed in one or more chips, the second region 333 may be formed in one or more chips, and the third region 335 may be formed in one or more chips.

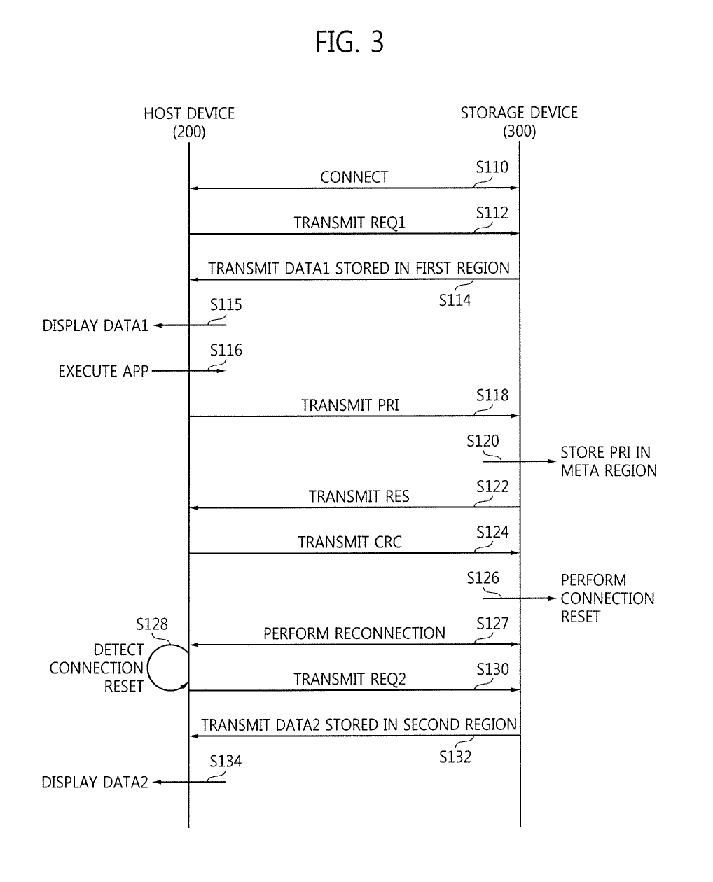

FIGS. 2A through 2E are conceptual diagrams showing the initialization of the data storage device 300 illustrated in FIG. 1 according to an exemplary embodiment of the inventive concept. FIG. 3 is a data flowchart showing an initialization procedure for initializing the data storage device 300 using the data processing system 100 illustrated in FIG. 1 according to an exemplary embodiment of the inventive concept. The initialization of the data storage device 300 will be described herein with reference to FIGS. 1 through 3.

When the data storage device 300 is connected to the host device 200 through the interface 101 in operation S110, an operating voltage is applied to the host interface 312 through the storage interface 216. The CPU 214, and more particularly, an OS being implemented by the CPU, detects the connection between the data storage device 300 and the host device 200 and generates a first request REQ1 according to the detection result. The CPU 214 transmits the first request REQ1 to the host interface 312 through the storage interface 216 in operation S112.

The host interface 312 transmits the first request REQ1 to the CPU 316 through the bus 314. The memory interface 320 transmits first data DATA1 stored in the first region 331 to the storage interface 216 through the host interface 312 according to the control of the CPU 316 in operation S114. The first data DATA1 includes the application APP. The first data DATA1 including the application APP is transmitted to the CPU 214 through the storage interface 216.

As shown in FIG. 2A, the CPU 214 calculates a size VOL1 (e.g., 128 MB) of the first region 331 based on the first data DATA1 and displays the size VOL1 on a display panel 251 of the display 250 through the display controller 220. When the data storage device 300 is recognized as a drive (e.g., a “D” drive in FIG. 2A) by the CPU 214, as shown in FIG. 2A, the size VOL1 of the first region 331 is displayed on the display panel 251.

When a user selects (e.g., clicks) on a GUI 251A in FIG. 2A, the first data DATA1 including an execution file APP.xxx 251B is displayed on the display panel 251, as shown in FIG. 2B, in operation S115. For example, the first data DATA1 including the execution file APP.xxx 251B for executing the application APP according to the control of the CPU 214 is displayed on the display panel 251. The execution file APP.xxx 251B is an execution program that can be executed by an OS run by the CPU 214. When the user selects (e.g., clicks) the execution file APP.xxx 251B, the application APP is executed by the CPU 214 in operation S116.

The application APP executed by the CPU 214 displays a GUI (e.g., a window) 251C, in which a product name can be entered (e.g., set up), on the display panel 251, as shown in FIG. 2C. The user enters a product name in the GUI 251C and clicks on a next button 251D. When the next button 251D is clicked on, the application APP executed by the CPU 214 displays a GUI (e.g., a window) 251E, which allows a password to be entered (e.g., set up), on the display panel 251, as shown in FIG. 2D.

At this time, when the user enters a password in the GUI 251E and clicks on a yes button 251F, the application APP executed by the CPU 214 transmits product registration information PRI to the host interface 312 through the storage interface 216 in operation S118. As described above, when the password is set up by the user, the product registration information PRI may include, for example, a product name, a password, and a first indicator bit. In an exemplary embodiment, the product name, the password, and the first indicator bit are all transmitted together to the data storage device 300. However, exemplary embodiments of the inventive concept are not limited thereto. For example, in an exemplary embodiment, the product name may be transmitted to the host interface 312 through the storage interface 216 prior to the indicator bit.

The memory interface 320 stores the product registration information PRI (e.g., the product name, the password, and the first indicator bit) received from the host interface 312 in the third region 335 according to the control of the CPU 316 in operation S120. However, when the user does not want to set up a password, the user clicks on a no button 251G (see FIG. 2D). The application APP executed by the CPU 214 transmits the product registration information PRI to the host interface 312 through the storage interface 216 in operation S118. The product registration information PRI may include, for example, the product name and a second indicator bit, as described above.

In an exemplary embodiment, the product name and the second indicator bit are transmitted together to the data storage device 300. However, exemplary embodiments of the inventive concept are not limited thereto. For example, in an exemplary embodiment, the product name may be transmitted to the host interface 312 through the storage interface 216 prior to the indicator bit. The memory interface 320 stores the product registration information PRI (e.g., the product name and the second indicator bit) received from the host interface 312 in the third region 335 according to the control of the CPU 316 in operation S 120.

When the product registration information PRI is completely stored in the third region 335, the CPU 316 generates a storing completion response RES and transmits the storing completion response RES to the storage interface 216 through the host interface 312 in operation S122. When the CPU 214 receives the storing completion response RES, the application APP executed by the CPU 214 generates a connection reset command CRC and transmits the connection reset command CRC to the host interface 312 through the storage interface 216 in operation S124.

The host interface 312 or the CPU 316 performs a connection reset in response to the connection reset command CRC in operation S126. The connection reset is a process of disconnecting and then reconnecting a certain line from among a plurality of lines included in the interface 101 connecting the storage interface 216 and the host interface 312 in operations S126 and S127. While the connection reset is being performed, the host device 200 maintains an operating voltage applied to the data storage device 300 through a voltage line from among the plurality of lines included in the interface 101.

When the storage interface 216 is reconnected with the host interface 312 through the connection reset in operation S127, the OS run by the CPU 214 detects the connection reset through the storage interface 216 in operation S128. The OS may detect the connection reset using, for example, a plug and play method.

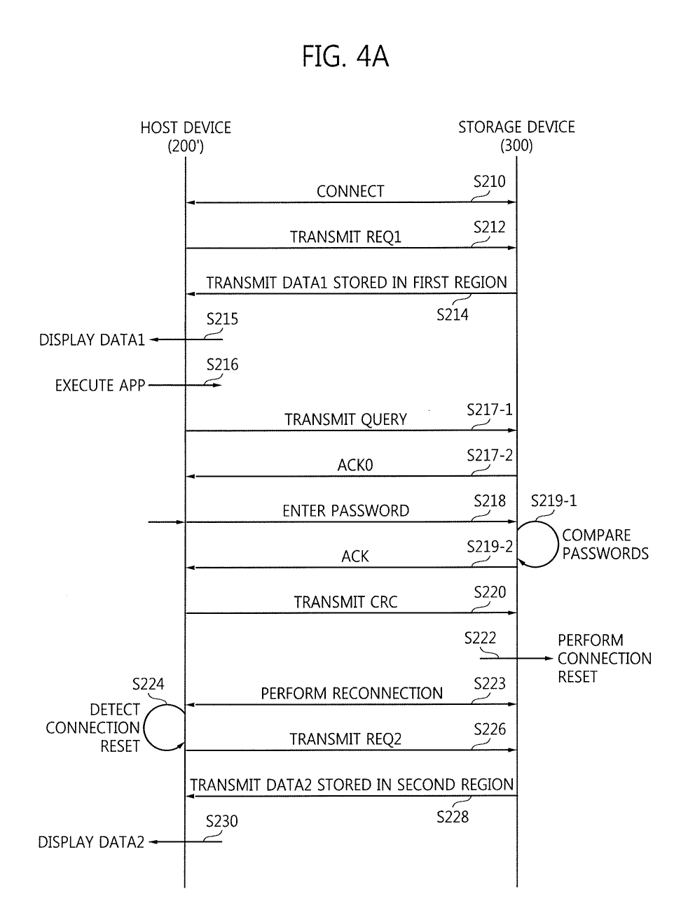

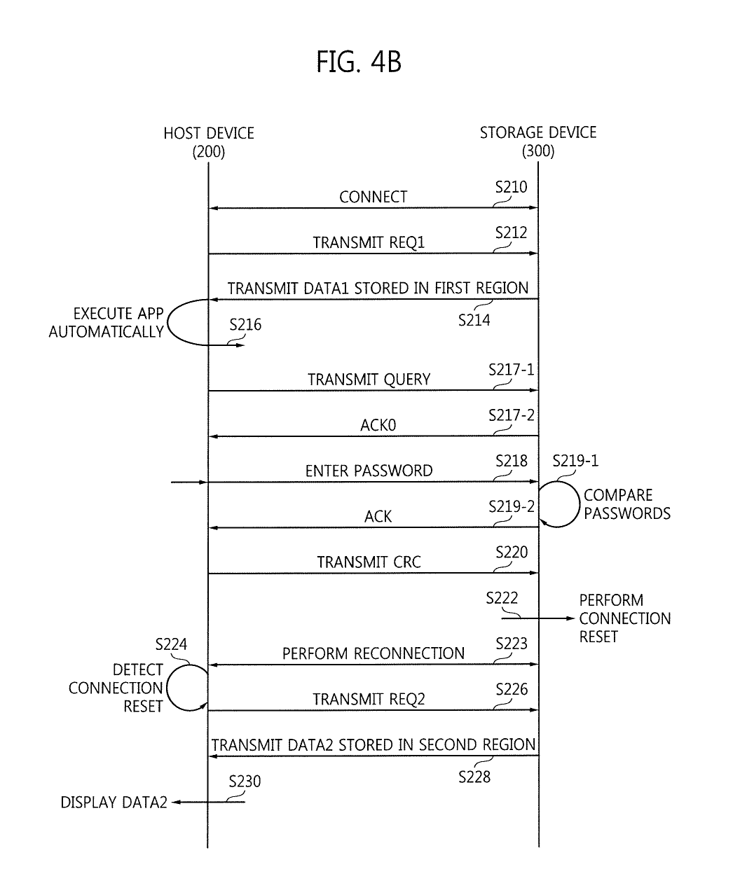

After the connection is reset, the OS run by the CPU 214 generates a second request REQ2 and transmits the second request REQ2 to the host interface 312 through the storage interface 216 in operation S130. For example, the application APP may transmit to the data storage device 300 a command related to at least one from among setting a product name, changing the product name, erasing the product name, setting a password, changing the password, and erasing the password. The second request REQ2 generated in operation S130 is substantially the same as the first request REQ1 generated in operation S112. Similarly, referring to FIG. 4A, the second request REQ2 generated in operation S226 is substantially the same as the first request REQ1 generated in operation S212.

The host interface 312 transmits the second request REQ2 to the CPU 316. The memory interface 320 transmits second data DATA2 stored in the second region 333 to the storage interface 216 through the host interface 312 according to the control of the CPU 316 in operation S132.

As shown in FIG. 2E, the CPU 214 calculates a size VOL2 of the second region 333 based on the second data DATA2 and displays the size VOL2 (e.g., 256 GB or 256 GB-128 MB) on the display panel 251 of the display 250 through the display controller 220 in operation S134. When the data storage device 300 is recognized as a drive (e.g., the “D” drive in FIG. 2E) by the CPU 214, as shown in FIG. 2E, the size VOL2 of the second region 333 is displayed on the display panel 251.

When the user selects (e.g., clicks on) a GUI 251H shown in FIG. 2E, the second data DATA2 is displayed on the display panel 251 in operation S134. Accordingly, the user can see the second data DATA2 stored in the second region 333. When no data is stored in the second region 333 during the initialization, the second data DATA2 may include no data.

According to exemplary embodiments, the CPU 214 may terminate the application APP or the application APP may continue to be executed in the background.

It is to be understood that the GUIs 251A through 251H illustrated in FIGS. 2A through 2E are merely examples provided to describe technical aspects of exemplary embodiments the inventive concept, and that exemplary embodiments of the inventive concept are not limited thereto.

FIGS. 4A and 4B are data flowcharts showing a procedure for accessing the data storage device 300 using the data processing system 100 illustrated in FIG. 1 according to an exemplary embodiment of the inventive concept. A method allowing a user who has set up a password to access the second region 333 through the procedures illustrated in FIGS. 2A through 3 will be described with reference to FIGS. 1 through 4A.

Referring to FIG. 4A, when the host device 200 that has performed initialization of the data storage device 300 is different from a host device 200′ that is connected with the data storage device 300, as shown in FIG. 4A, GUIs similar to or the same as those illustrated in FIGS. 2A, 2B, 2D, and 2E may be sequentially displayed on the display panel 251. The structure and operations of the host device 200 are substantially the same as those of the host device 200′, and the application APP is executed by a user's choice.

When the data storage device 300 is connected to the host device 200′ after being completely disconnected from the host device 200 in operation S210, an operating voltage is applied to the host interface 312 through the storage interface 216. The CPU 214, and more particularly, an OS implemented by the CPU 214, detects the connection between the data storage device 300 and the host device 200′ and generates the first request REQ1 according to the detection result. The CPU 214 transmits the first request REQ1 to the host interface 312 through the storage interface 216 in operation S212.

The host interface 312 transmits the first request REQ1 to the CPU 316. The memory interface 320 transmits the first data DATA1 stored in the first region 331 to the storage interface 216 through the host interface 312 according to the control of the CPU 316 in operation S214. The first data DATA1 includes an application APP. The first data DATA1 including the application APP is transmitted to the CPU 214 through the storage interface 216.

As shown in FIG. 2A, the CPU 214 calculates the size VOL1 of the first region 331 based on the first data DATA1 and displays the size VOL1 on the display panel 251 of the display 250 through the display controller 220.

When a user selects (e.g., clicks on) the GUI 251A in FIG. 2A, the first data DATA1 including the execution file APP.xxx 251B is displayed on the display panel 251, as shown in FIG. 2B, in operation S215. When the user selects (e.g., clicks on) the execution file APP.xxx 251B, the application APP is executed by the CPU 214 in operation S216.

The application APP executed by the CPU 214 transmits a query to the CPU 316 of the data storage device 300 through the interfaces 216 and 312 in operation S217-1. The CPU 316 that has received the query transmits an acknowledgement signal ACK0 to the CPU 214 through the interfaces 216 and 312 based on the password and the first indicator bit stored in the third region 335 in operation S217-2. The acknowledgement signal ACK0 indicates that the password has been stored in the third region 335.

The application APP executed by the CPU 214 displays the GUI 251E, which allows a password to be entered, on the display panel 251, as shown in FIG. 2D, based on the acknowledgement signal ACK0. When the user enters a password in the GUI 251E and clicks on the yes button 251F, the application APP executed by the CPU 214 transmits the password to the CPU 316 through the interfaces 216 and 312 in operation S218. The CPU 316 compares the password stored in the third region 335 with the currently entered password in operation S219-1. The CPU 316 transmits a response ACK indicating whether the passwords match to the CPU 214 through the interfaces 216 and 312 in operation S219-2.

When the CPU 214 receives the response ACK, the application APP executed by the CPU 214 generates the connection reset command CRC and transmits the connection reset command CRC to the host interface 312 through the storage interface 216 in operation S220. The host interface 312 or the CPU 316 performs a connection reset in response to the connection reset command CRC in operation S222.

When the storage interface 216 is reconnected with the host interface 312 through the connection reset in operation S223, the OS run by the CPU 214 detects the connection reset through the storage interface 216 in operation S224. The OS run by the CPU 214 generates the second request REQ2 based on the detection result and transmits it to the host interface 312 through the storage interface 216 in operation S226.

The host interface 312 transmits the second request REQ2 to the CPU 316. The memory interface 320 transmits the second data DATA2 stored in the second region 333 to the storage interface 216 through the host interface 312 according to the control of the CPU 316 in operation S228.

As shown in FIG. 2E, the CPU 214 calculates the size VOL2 of the second region 333 based on the second data DATA2 and displays the size VOL2 on the display panel 251 of the display 250 through the display controller 220. When the user selects (e.g., clicks on) the GUI 251H shown in FIG. 2E, the second data DATA2 is displayed on the display panel 251 in operation S230. Accordingly, the user can see the second data DATA2 stored in the second region 333.

According to exemplary embodiments, the CPU 214 may terminate the application APP or the application APP may continue to be executed in the background.

Referring to FIG. 4B, when the host device 200 that has performed initialization of the data storage device 300 is the same as the host device 200 that is connected with the data storage device 300, as shown in FIG. 4B, operations corresponding to FIGS. 2A through 2C may be omitted. For example, as shown in FIG. 4B, after operation S214 is performed, the application APP may be automatically executed by the CPU 214 in operation S216.

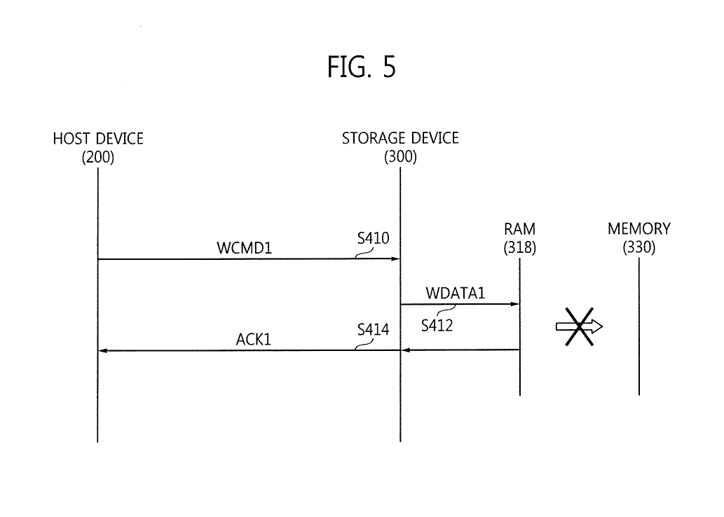

FIG. 5 is a data flowchart showing a procedure for processing a write command for a write-protected read-only region using volatile memory according to an exemplary embodiment of the inventive concept. A procedure in which the data storage device 300 processes a write command for the first region 331 (e.g., the write-protected read-only region) and data corresponding to the write command using the RAM 318 will be described with reference to FIGS. 1, 2A through 2E, and 5. The RAM 318 is recognized by the host device 200 as the first region 331.

While the application APP is being executed, the host device 200 transmits every write command WCMD1 for the first region 331 to the CPU 316 through the interfaces 216 and 312 in operation S410. The CPU 316 writes write data WDATA1 corresponding to the write command WCMD1 to the RAM 318 in operation S412. Accordingly, any write data WDATA1 for the first region 331 is not written to the first region 331, so that data that has been stored in the first region 331 is not damaged.

When all write data WDATA1 is completely written to the RAM 318, the CPU 316 of the data storage device 300 transmits a write completion response ACK1 to the CPU 214 through the interfaces 216 and 312 in operation S414. The OS run by the CPU 214 of the host device 200 determines that every write command WCMD1 for the first region 331 has been normally processed by the data storage device 300 based on the write completion response ACK1. In other words, the data storage device 300 deceives the OS run by the CPU 214 by transmitting the write completion response ACK1. Transmitting a fake response to the write command WCMD1 allows a shadow MBR to be used for a secondary drive regardless of the characteristics of the OS in the host device 200.

Since all write data WDATA1 for the first region 331 has been stored in the RAM 318 before the second region 333 is accessed by the host device 200, all write data WDATA1 for the first region 331, which has been stored in the RAM 318, can be read by the host device 200 while an operating voltage is being applied to the data storage device 300. However, when the data storage device 300 is disconnected from the host device 200 or the operating voltage for the data storage device 300 is cut off, all write data WDATA1 stored in the RAM 318 for the first region 331 disappears. Accordingly, the data that has been stored in the first region 331 is maintained as it is.

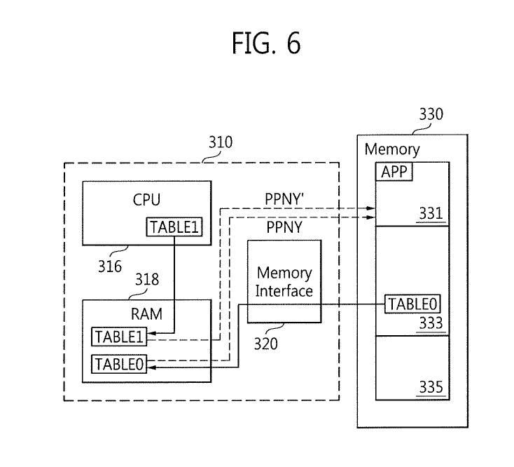

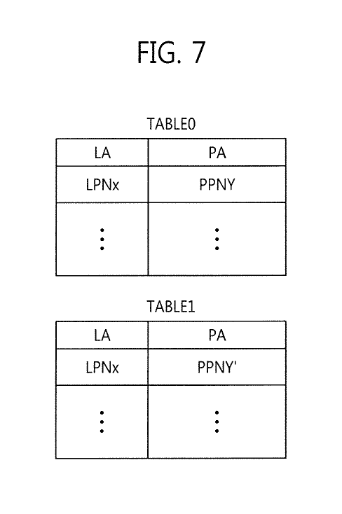

FIG. 6 is a diagram showing data flow in a procedure for processing a write command for a write-protected read-only region using non-volatile memory according to an exemplary embodiment of the inventive concept. FIG. 7 is a diagram of a new address mapping table generated for the procedure illustrated in FIG. 6 according to an exemplary embodiment of the inventive concept. A procedure in which the data storage device 300 processes a write command for the first region 331 (e.g., the write-protected read-only region) and data corresponding to the write command using the memory 330 will be described with reference to FIGS. 1, 2A through 2E, 6 and 7.

It is assumed that an original address mapping table TABLE0 is loaded from the second region 333 to the RAM 318, and a new address mapping table TABLE1 is generated by the CPU 316 of the data storage device 300 and then loaded to the RAM 318. The data storage device 300, and more particularly, the CPU 316 may generate the new address mapping table TABLE1 to process a write command for the first region 331 (e.g., the write-protected read-only region). In the tables TABLE0 AND TABLE1, reference characters LA and PA denote a logical address and a physical address, respectively.

Referring to the original address mapping table TABLE0, a first logical address LPNx is mapped to a first physical address PPNY of the first region 331. The first logical address LPNx may indicate an x-th logical page number and the first physical address PPNY may indicate a Y-th physical page number. Here, x and Y may be integers equal to or greater than 0. It is to be understood that exemplary embodiments of the inventive concept are not limited to the current example.

While the application APP is being executed, before the first region 331 is transformed to the second region 333, or before the host device 200 accesses the second region 333, the OS run in the host device 200 transmits a write command for the first region 331 to the CPU 316 through the interfaces 216 and 312. The CPU 316 generates the new address mapping table TABLE1 in response to the write command for the first region 331. For example, the CPU 316 maps the first logical address LPNx to a second physical address PPNY′ of the first region 331. The new address mapping table TABLE1 that defines mapping between the first logical address LPNx and the second physical address PPNY′ is stored in the RAM 318.

The memory interface 320 writes write data corresponding to the write command for the first region 331 to the first region 331 corresponding to the second physical address PPNY′, referring to the new address mapping table TABLE1 stored in the RAM 318, according to the control of the CPU 316. For example, the memory interface 320 writes the write data to a memory space corresponding to the second physical address PPNY′ in the first region 331 instead of a memory space corresponding to the first physical address PPNY in the first region 331.

Although write data corresponding to a write command for the first region 331 is written to the first region 331 in the exemplary embodiment illustrated in FIG. 6, exemplary embodiments are not limited thereto. For example, according to exemplary embodiments, the memory space corresponding to the second physical address PPNY′ may be allocated in any place in the memory 330. Before the host device 200 accesses the second region 333, the CPU 316 of the data storage device 300 transmits a write completion response to the CPU 214 through the interfaces 216 and 312 when all write data corresponding to every write command for the first region 331 is completely written to the first region 331.

The OS run by the CPU 214 determines that every write command for the first region 331 has been normally processed by the data storage device 300 based on the write completion response. In other words, the data storage device 300 deceives the OS run by the CPU 214 by outputting the write completion response. Outputting a fake write completion response allows a shadow MBR to be used for a secondary drive regardless of the characteristics of the OS in the host device 200.

When the data storage device 300 is disconnected from the host device 200 or the operating voltage for the data storage device 300 is cut off, the tables TABLE0 and TABLE1 stored in the RAM 318 are erased or disappear since the RAM 318 is a volatile memory. However, the original address mapping table TABLE0 stored in the second region 333 is retained. In addition, original data stored in the first region 331 is not overwritten with all write data corresponding to every write command for the first region 331 according to the new address mapping table TABLE1. As a result, the original data in the first region 331 is maintained without being damaged.

As described above, the data storage device 300 stores write data corresponding to a write command for the first region 331 (e.g., the write-protected read-only region) in the RAM 318 or the memory 330, and transmits a fake response to the OS in the host device 200 or 200′, so that the first region 331 (e.g., a shadow MBR) can be used for a secondary drive. When the data storage device 300 is used as the secondary drive of the data processing system 100, the data storage device 300 may output a fake response with respect to a write command for the first region 331 (e.g., the shadow MBR). Although the host device 200, and more particularly, the OS is deceived using the RAM 318 or the memory 330 in the above-described exemplary embodiments, exemplary embodiments are not limited to these examples. For example, write data corresponding to a write command for the first region 331 (e.g., the write-protected read-only region) can be stored in any memory or storage device that can be recognized by the host device 200 as the first region 331.

As described above, according to exemplary embodiments of the inventive concept, a data storage device processes write data corresponding to a write command for a write-protected read-only region using RAM separated from the region. As a result, when an operating voltage applied to the data storage device is cut off, original data stored in the write-protected read-only region is maintained since the write data stored in the RAM is erased.

According to exemplary embodiments of the inventive concept, a data storage device generates a new address mapping table in addition to an original address mapping table to process a write command for a write-protected read-only region, and writes data corresponding to the write command to memory including the write-protected read-only region using the new address mapping table. At this time, the data storage device stores the new address mapping table in RAM. As a result, when an operating voltage applied to the data storage device is cut off, data stored in the write-protected read-only region is maintained since the new address mapping table stored in the RAM is erased.

In addition, according to exemplary embodiments of the inventive concept, the data storage device transmits a fake response to the write command for the write-protected read-only region to an OS in a host device, allowing a shadow MBR to be used for a secondary drive regardless of the characteristics of the OS in the host.

While the inventive concept has been particularly shown and described with reference to the exemplary embodiments thereof, it will be understood by those of ordinary skill in the art that various changes in form and detail may be made therein without departing from the spirit and scope of the inventive concept as defined by the following claims.

What is claimed is:

1. A method of operating a data storage device which operates according to control of a host, the method comprising:
receiving an operating voltage from the host;
transmitting first data stored in a first region of the data storage device to the host in response to a first request transmitted by the host;
storing product registration information transmitted from the host in a meta region of the data storage device;
resetting a connection between the data storage device and the host in response to a connection reset command output from the host; and
transmitting second data stored in a second region of the data storage device to the host in response to a second request transmitted by the host after the connection is reset,
wherein the first data includes an application executed by the host.

2. The method of claim 1, wherein the first region is smaller than the second region.

3. The method of claim 1, wherein the first region is a write-protected read-only region and the second region is a user data region to which user data is written.

4. The method of claim 1, wherein the product registration information includes a product name and a password.

5. The method of claim 1, wherein the product registration information includes a product name and indicator data indicating whether a password has been set, and the indicator data includes the password when the password has been set.

6. The method of claim 1, further comprising:
receiving a write command for the first region from the host while the application is being executed by the host;
storing write data corresponding to the write command in a random access memory (RAM) included in the data storage device; and
transmitting a response to the write command to the host.

7. The method of claim 1, further comprising:
receiving a write command for the first region from the host while the application is being executed by the host;
generating a new address mapping table for write data corresponding to the write command;
storing the write data in the first region using the new address mapping table; and
transmitting a response to the write command to the host.

8. The method of claim 7, further comprising:
storing the new address mapping table in a random access memory (RAM) included in the data storage device.

9. The method of claim 1, wherein the product registration information and the connection reset command are transmitted from the host by the application executed by the host.

10. The method of claim 1, wherein the data storage device is one of a solid state drive (SSD), a universal flash storage (UFS), a universal serial bus (USB) flash drive, a multimedia card (MMC), and a hard disk drive.

11. A method of operating a data storage device which operates according to control of a host, the method comprising:
receiving an operating voltage from the host;
transmitting first data stored in a first region of the data storage device to the host in response to a first request transmitted by the host;
receiving a first password from the host;
comparing a second password stored in a meta region of the data storage device with the first password;
transmitting an acknowledgement signal to the host in response to determining that the first password matches the second password;
resetting a connection between the data storage device and the host in response to a connection reset command output from the host based on the acknowledgement signal; and
transmitting second data stored in a second region of the data storage device to the host in response to a second request transmitted by the host after the connection is reset,
wherein the first data includes an application executed by the host.

12. The method of claim 11, further comprising:
receiving a write command for the first region from the host while the application is being executed by the host;
storing write data corresponding to the write command in a random access memory (RAM) included in the data storage device; and
transmitting a response to the write command to the host.

13. The method of claim 11, further comprising:
receiving a write command for the first region from the host while the application is being executed by the host;
generating a new address mapping table for write data corresponding to the write command;
storing the write data in the first region using the new address mapping table; and
transmitting a response to the write command to the host.

14. The method of claim 13, further comprising:
storing the new address mapping table in a random access memory (RAM) included in the data storage device.

15. The method of claim 11, wherein the first password and the connection reset command are transmitted from the host by the application executed by the host.

16. A data storage device, comprising:
a memory comprising a first region configured to store an application executed by a host, a second region configured to store user data, and a meta region; and
a storage controller configured to control an operation of the memory, wherein the storage controller is further configured to:
transmit first data to the host in response to a first request received from the host upon the storage controller being connected to the host, wherein the first data includes the application stored in the first region,
store product registration information transmitted from the host in the meta region,
reset a connection between the data storage device and the host in response to a connection reset command received from the host, and
transmit second data stored in the second region to the host in response to a second request received from the host after the connection is reset.

17. The data storage device of claim 16, wherein the first region is smaller than the second region.

18. The data storage device of claim 16, wherein the first region is a write-protected read-only region and the second region is a user data region to which the user data is written.

19. The data storage device of claim 16, wherein the product registration information includes a product name and a password.

20. The data storage device of claim 16, wherein the product registration information includes a product name and indicator data indicating whether a password has been set, and the indicator data includes the password when the password has been set.
